(19) United States
(12) Patent Application Publication
(10) Pub. No.: US 2006/0143090 A1
(43) Pub. Date: Jun. 29, 2006

(54) Method and system for identifying wireless network coverage gaps

(76) Inventors: Barry Ridings, Fayetteville, AR (US); Loren R. Lawrence, Rogers, AR (US); Dean Kawaguchi, San Jose, CA (US); Ron Zancola, Commack, NY (US); Paul Cowan, Hinckley, OH (US)

Correspondence Address: Fay Kaplun & Marcin, LLP, Suite 702, 150 Broadway, New York, NY, 10038, US

(21) Appl. No.: 11/022,911

(22) Filed: Dec. 27, 2004

(51) Int. Cl. G06Q 30/00

(52) U.S. Cl. 705/26; 705/17

(57) ABSTRACT

Described is a system which includes a wireless arrangement and a mobile unit. The mobile unit may include a wireless transducer and a data acquisition arrangement (“DAA”) which obtains identification data from an item located at a predetermined location. The wireless transducer sends a transmission to the wireless arrangement which includes the identification data and wireless transmission data. The wireless arrangement analyzes the identification data to determine the predetermined location and wireless coverage data at the location as a function of the transmission data.

### BACKGROUND INFORMATION

In the few years since the Institute of Electrical and Electronics Engineers (“IEEE”) approved the 802.11 wireless local area network (“WLAN”) standard, the proliferation of wireless communication and computing products compliant with this technology has been exceptional. A wireless network generally includes access points (“APs”) which provide a wireless connection to the wireless network for mobile computing units using radio frequency (“RF”) signals.

Wireless networks are frequently utilized in locations in which a large number of mobile units require access to the wireless network, a central server and/or a database. For example, in a retail environment, specifically in a large retail outlet, a plurality of mobile units may be used at any one time to perform routine retail inventory functions, such as retrieving data from inventory items (e.g., scanning barcodes). These mobile units are connected to the wireless network in order to transmit the data to the central server or database. In the retail environment, the data may represent, for example, a number of items presently on a shelf, a location of an item within a store, etc.

Typically, the wireless network may experience problems with an RF coverage because the wireless connections between the mobile units and the APs are prone to interruptions and interference. Interruptions and interference with the RF signals to/from the mobile units may cause coverage gaps in the wireless network. Therefore, wireless network operators are forced to perform routine maintenance, including identifying and fixing the coverage gaps, which may represent significant time and cost to a proprietor of the wireless network (e.g., owner of retail outlet).

Conventional methods for identifying the coverage gaps generally require a user to roam around a geographical area of the RF coverage of the wireless network with a monitoring device that records a signal strength of the RF signals. However, this method requires trained personnel and use of specialized equipment. Therefore, there is a need for a method to identify the coverage gaps in the wireless networks without using costly and complicated conventional methods.

### SUMMARY OF THE INVENTION

The present invention relates to a system and method for detecting coverage gaps in a wireless network using a mobile unit adapted for obtaining identification data from items and connected to the wireless network. The mobile unit collects transmission data regarding the wireless network and transmits the identification and the transmission data to a wireless arrangement. The wireless arrangement includes a database containing location of the items allowing the wireless arrangement to determine the location of the mobile unit with respect to the items and thereby determine the wireless coverage at the location as a function of the identification and transmission data.

### BRIEF DESCRIPTION OF THE DRAWINGS

FIG. 1 is an exemplary embodiment of a system for identifying coverage gaps in a wireless network according to the present invention.

FIG. 2 is an exemplary embodiment of a method for identifying coverage gaps in a wireless network according to the present invention.

### DETAILED DESCRIPTION

The present invention may be further understood with reference to the following description and the appended drawings, wherein like elements are provided with the same reference numerals. The present invention provides a system and a method for identification of coverage gaps in a wireless network (e.g., WLAN). An exemplary embodiment of the present invention will be described in the context of a retail environment, however, one skilled in the art will understand that the present invention is not limited to such an environment, but may be utilized in other locations that employ wireless networks.

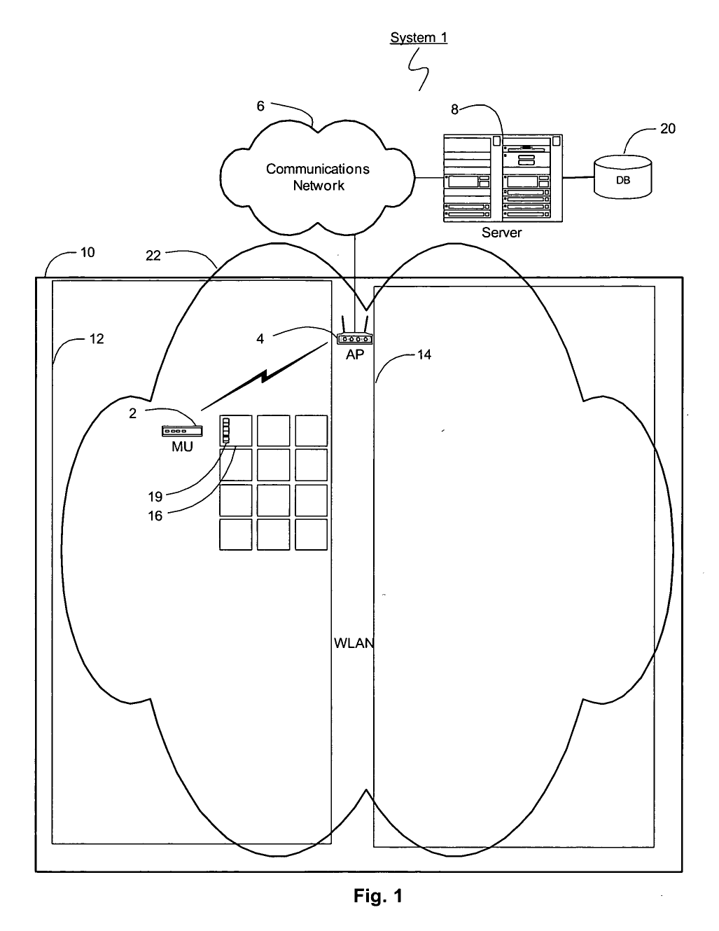

FIG. 1 shows an exemplary embodiment of a system 1 for identifying coverage gaps in a wireless network according to the present invention. The system 1 includes a server 8 which may be connected to a database 20 and a communications network 6. The network 6 may allow one or more WLANs 22 to access the server 8 and/or the database 20 connected thereto. The WLAN 22 may include an access point (“AP”) 4 which provides a wireless connection for a mobile unit (“MU”) 2 to the network 6.

Those skilled in the art will understand that the WLAN 22 may include a plurality of APs. The AP 4 may be any wireless infrastructure device (e.g., wireless hub, router, switch, etc.) connected to the network 6 that provides wireless network access to devices on the WLAN 22. Thus, the WLAN 22 allows the MU 2 to be connected to the network 6 through the AP 4.

The network 6 may be any communications network comprising a plurality of infrastructure components which interconnect computing devices (e.g., hubs, switches, servers, etc.). The network 6 is connected to the server 8, which may be located within or outside of a store 10. The server 8 may be a computing arrangement that includes memory (e.g., RAM, non-volatile, etc.), storage (e.g., hard drives, optical drives, etc.), processor(s), and any other internal circuitry necessary for the server 8 to perform its functions.

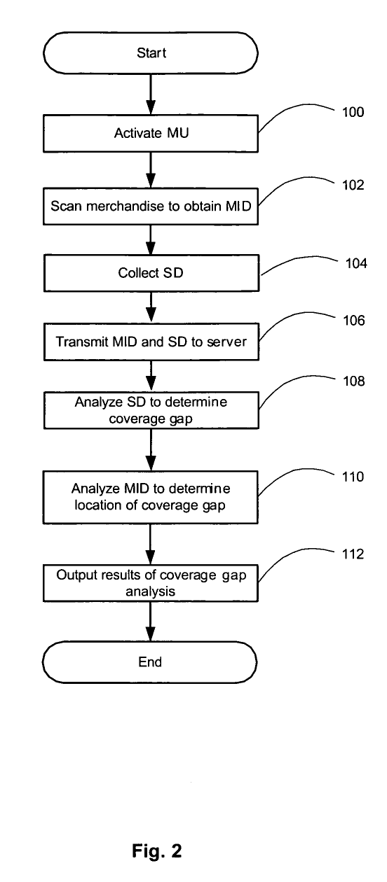

The server 8 may be responsible for managing the network 6 of the store 10, or the server 8 may be a centralized server having a broader scope. That is, the store 10 may be only one of a plurality of retail outlets, and the server 8 manages the networks of all of the stores from a central location. In an exemplary embodiment, the server 8 may be responsible for managing the network 6 and the WLAN 22. For example, the server 8 may store data about the network 6 and the WLAN 22. The data may include operational status of the APs and the MUs, an RF coverage area of the APs, MAC addresses of the APs and the MUs, etc. This data may facilitate management of the WLAN 22. For example, if certain APs are not operational, the server 8 is notified so that appropriate action may be taken (e.g., repair or replacement of the faulty AP). In addition, the server 8 may be configured to receive information about the status of the RF coverage of the WLAN 22 from the MUs, as shown in FIG. 2 and discussed in more detail below.

According to the present invention, the system 1 may be utilized in a defined environment, such as the store 10, a warehouse, a supermarket, etc. The store 10 may include a plurality of departments 12, 14. The department 12 may include merchandise 16 arranged for display and sale therein. For example, the department 12 may be an electronics department which sells home audio and video equipment (e.g., stereos, speakers, amplifiers, etc.)

The merchandise 16 and/or a package containing the merchandise 16 may include a tag 19 which identifies and/or contains data regarding the merchandise 16 (e.g., price, inventory location, store location, universal product code (“UPC”)). The tag 19 may be, for example, a barcode or an RFID tag. As understood by those skilled in the art, the tag 19 may be positioned anywhere on the merchandise 16 or the package, but is preferably in a readily visible or an easily accessible location.

The MU 2 may be a mobile computing device that includes a scanning arrangement to obtain and/or modify the data about the merchandise 16 from the tag 19. For example, if the tag 19 is the barcode, the MU 2 may include an optical scanner for reading the barcode. If the tag 19 is the RFID tag, the MU 2 may include an RFID interrogator. Furthermore, the MU 2 may include additional circuitry and a processing arrangement allowing the MU 2 to perform its functions (e.g., scanning, modifying the merchandise data, etc.). The MU 2 may further include a radio frequency communications arrangement allowing it to communicate with the AP 4 according to a wireless communications protocol (e.g., IEEE 802.11a-g protocols, etc.). In this manner, the MU 2 may transmit/receive RF signals to/from the AP 4, thereby allowing the MU 2 to access the server 8, the database 20 and other devices that may be connected to the network 6.

In the exemplary embodiment of the present invention, the database 20 may store data pertinent to retail operations of the store 10. For example, the database 20 may include information regarding a physical layout of the store 10 and the departments 12, 14. In addition, the database 20 may include information regarding the merchandise 16 (e.g., inventory status, location within the department 12, pricing, etc.). More specifically, the database 20 contains information of the location of the merchandise 16 within the store 10 (e.g., a map showing the location of the merchandise 16).

The information about the merchandise 16 is generally obtained from a plurality of sources (e.g., other servers, the MU 2, etc.). For example, other servers may provide information regarding incoming shipments, whereas MU 2 may provide real-time updates on inventory status within the store 10. Thus, if the MU 2 finished taking the inventory of the merchandise 16, updated inventory data may be transmitted to and stored in the database 20. The MU 2 can send the updated information to the server 8 via the AP 4, the WLAN 22 and the network 6, thereby allowing the server 8 to receive updated data regarding the merchandise 16 directly from the MU 2.

According to the present invention, the server 8 may detect coverage gaps in the WLAN 22 using one or both of two types of data, a location data and a signal data (“SD”). The location data may include a position of the MU 2 within the store 10 obtained by, for example, comparing a merchandise identification data (“MID”) collected by the MU 2 with a map of the department 12 stored within the database 20. The MID may include an identity of the merchandise 16 and a record of the activity performed by the MU 2 on the merchandise 16 (e.g., scanning the merchandise 16).

The SD may include a status report on the quality and/or availability of the wireless connection between the MU 2 and the AP 4. In addition, the SD may further include ping data between the MU 2. The server 8 combines the location data with the SD to determine an RF coverage of the WLAN 22. Thus, the existing infrastructure of a retail environment may be used to determine a location of the RF coverage of the WLAN 22 within the store 10.

FIG. 2 shows an exemplary embodiment of a method for identifying coverage gaps in the wireless network according to the present invention. In step 100, a user activates the MU 2. The activation may include powering up the MU 2, waking it from hibernation, or logging in the user. The activation process may also include selecting the store 10 and/or the department 12 within the store 10 in which the user intends to use the MU 2. For example, if the user intends to operate on the merchandise 16, the user would enter that the MU 2 is presently within the department 12. User-entered location data is less desirable than automatically obtained location data as discussed below. Therefore, user-entered location data may be a redundant component of a location-obtaining method whereby the user-entered location data is subsequently verified by the MU 2 and the server 8.

In step 102, the MU 2 obtains the MID by, for example, scanning the tag 19 on the merchandise 16 or the package thereof. During scanning, the MU 2 collects the MID (e.g., type of merchandise scanned, the time of the scan, etc.) which is stored locally. Furthermore, the MID may be collected automatically (e.g., whenever the MU 2 is scanning merchandise 16) or manually (e.g., the user must instruct the MU 2 to collect the MID). Prior to collecting MID, the MU 2 may prompt the user to verify that the location of the scanning is the same as the location entered by the user in step 102. The MID is later transmitted to the server 8 for analysis as discussed below.

In step 104, the MU 2 obtains the SD. The SD may include RF statistics related to the WLAN 22 (e.g., signal strength, device identification, etc.). For example, if the WLAN 22 is based on the Spectrum 24® protocol available from Symbol Technologies®, Inc., Holtsville, N.Y., the MU 2 may collect and record the following signal strength statistics which the Spectrum 24 protocol facilitates: a received signal strength indicator (RSSI) of the receiver, a percent of beacons missed by the MU 2, a percent of cyclic redundancy check (CRC) errors of the receiver, and a percent of attempted retransmissions. The RSSI provides a measurements of the strength of the RF signals. The CRC errors may indicate that the connection between the AP 4 and the MU 2 is poor, because the MID became corrupt.

In addition to signal strength statistics, the MU 2 also obtains infrastructure identifying information about the devices on the WLAN 22. For example, the MU 2 may record the MAC addresses, basic service set identifiers (“BSSIDs”) and service set identifiers (“SSIDs”) of itself and the AP 4, depending on which identifiers are utilized. Furthermore, the MU 2 may also record other identifying information, for example, an identity of the store 10, if the store 10 is one of a plurality of outlets. The infrastructure identifying information allows network managers to determine which devices on the WLAN 22 or the network 6 are responsible for RF signal failures.

The MU 2 may further determine and obtain ping data. Those skilled in the art will understand that the MU 2 may be configured to perform various tests on the WLAN 22 and the network 6. Ping data is similar to the RF SD because it provides information concerning the connection of the MU 2 to the WLAN 22 and/or the network 6. To obtain ping data, the MU 2 may perform ping tests on various devices on the network 6 or the WLAN 22 to determine the transmission time for the ping (e.g., 3 ms) or if a connection even exists (i.e., ping timeout denotes there is no connection). Results of the ping tests may be recorded and saved in a file on the MU 2.

In certain situations, the MU 2 may not have a wireless connection because it may be outside the coverage of the WLAN 22, or the AP 4 may not be operational. Therefore, the MU 2 may not be able to obtain any radio frequency statistics or the ping data. In this case, the SD may include data indicating that the MU 2 was unable to connect to the WLAN 22 and/or the AP 4. However, the MU 2 may obtain the ping data from the AP 4 even if, for example, the server 8 appears gone (e.g, routing between WLAN 22 and the server 8 has been removed). That is, the AP 4 may remain pingable.

In step 106, the MID and the SD are transmitted to the server 8. Prior to transmission, collection of the MID and the SD may be terminated. Termination of recording process may be automatic (e.g., once the user finishes scanning the merchandise 16 the collection is terminated) or manual (e.g., scanning continues until the user terminates the scan). Once the scanning process is terminated the MID and the SD are transmitted to the server 8 via the network 6.

In a further exemplary embodiment of the present invention, the MID and the SD are transmitted to the server 8 upon reaching a predefined condition (e.g., number of scans, time, etc.). Thus, the user of the MU 2 may be unaware that the MID and the SD are being transmitted to the server 8. In yet a further exemplary embodiment, the SD that is obtained and transmitted to the server 8 may be limited. For example, the MU 2 may obtain and transmit the MID and the SD only for merchandise with a particular characteristic, such as system code “4” or “in-store” barcodes. As understood by those skilled in the art, these barcodes may indicate a location (e.g., shelf, display, etc.) within the store 10.

The data transmission from the MU 2 to the server 8 may be either through a wireless connection (e.g., through the WLAN 22) or a wired connection. The MU 2 may transmit data files using the AirBEAM® available from Symbol®. Preferably a wireless connection is used, however, where a wireless connection is unavailable (e.g., the MU 2 is outside the coverage of the WLAN 22, the AP 4 is not operational) a wired connection may be used as a substitute. If a wired connection is used, the data collected during the steps 102 and 104 is transmitted from a different location and at a later time, such as, when the MU 2 is connected to the network 6 (e.g., docked at a computer terminal connected to the network 6).

Furthermore, the transmission step may be used to provide additional information for the SD. For instance, if during an attempted wireless transmission through the AP 4, the MU 2 discovers that it no longer has a wireless connection, that disruption in the connection would be added to the SD creating augmented SD. The augmented SD containing the failed transmission would be transmitted using a wired connection as discussed above.

As the data collected by the MU 2 is relayed to the server 8 through various WLAN 22 components (e.g., the AP 4) and/or infrastructure components of the network 6, the transmission may be timestamped to provide additional SD. For example, as the MU 2 transmits the collected data it would add the date and time of the transmission. The AP 4, upon the receipt of the data would include the date and time for that activity, as well as include the date and time that the data was relayed to the network 6. The timestamps may supplement the SD because they provide information on a total time that a transmission from the MU 2 takes to reach the server 8.

In steps 108 and 110, the server 8 processes and analyzes the MID and the SD transmitted from the MU 2. As understood by those skilled in the art, the server 8 may store the transmitted MID and the SD locally allowing the MU 2 to delete the data stored therein since the MU 2 storage capabilities are limited. The data may be stored on the server 8 based on a predetermined directory structure. For example, the data from the MU 2 may be sorted based on the MAC address of the MU 2. In addition, if the MU 2 has previously transmitted files to the server 8, the server 8 may store the files in a directory corresponding to the MU 2 without overwriting previous files. Such storage allows the server 8 to maintain an organized record of the MID and the SD which may be used to prepare long-term comprehensive wireless connection analyses.

In step 108, the server 8 analyzes the SD to determine whether the coverage gap exists. The server 8 compares the SD to acceptable parameters. For example, if the RSSI below the preset parameter or if there were more CRC check failures than allowed by a network setting, the server 8 may note that there is a signal fault within the WLAN 22. In addition, if the MU 2 could not transmit the collected data through the wireless connection, the server 8 would indicate that there was a critical failure in the RF coverage of the WLAN 22.

The server 8 analyzes the ping data and timestamps to determine the stability of the wireless connection between the MU 2 and the network 6. This allows for analysis of infrastructure components which are part of the network 6. Thus, the ping data and timestamps allow the server 8 to identify connectivity problems caused by the network 6, as well as the WLAN 22. In addition to the above-identified data, the server 8 parses the infrastructure identifying information transmitted from the MU 2 in order to determine which devices on the WLAN 22 or the network 6 are responsible for signal failures. The infrastructure identifying information also allows the server 8 to properly sort and store the received data.

In step 110, the server 8 analyzes the MID to obtain location data and determine the position of the coverage gap within the WLAN 22. The MID includes information on the activities the MU 2 performed on merchandise(e.g., identity of the merchandise, time of the activity, location of the activity, etc.). As discussed above, the server 8 stores the location of the merchandise 16 within the database 20. Thus, if the server 8 is aware that the MU 2 was scanning the merchandise 16, the server 8 can determine the location of the MU 2 in relation to the location of the merchandise 16. This allows the server 8 to determine the location of the coverage gap within the WLAN 22, because the location of the MU 2 may correspond to the location of the coverage gap by combining the SD and the location of the MU 2 during scanning. Since the SD designating the coverage gap was obtained during scanning of the merchandise 16, the server 8 can determine that the coverage gap exists at the location of the scanning activity.

In step 112, after analyzing the coverage gaps, the server 8 may output the analysis for network managers. Those skilled in the art will understand that output of the analysis may be in a plurality of formats (e.g., print out, saved file, display, etc.). The output allows network managers to take appropriate action in response to the identified coverage gaps in the WLAN 22 (e.g., install additional APs, extend existing coverage of the APs, etc.).

The present invention utilizes the existing infrastructure of the retail environment (e.g., APs, scanners, merchandise location, etc.) to identify gaps in the wireless network coverage. The server 8 determines whether the network gap exists based on the SD and where that network gap occurred based on the location data. This method does not rely on any specialized equipment or additional components, thereby minimizing the cost and time involved in mapping out and maintaining the WLAN 22.

The present invention has been described with the reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a wireless arrangement; and
a mobile unit including a wireless transducer and a data acquisition arrangement (“DAA”), the DAA obtaining identification data from an item, the item being located at a predetermined location,
wherein the wireless transducer sends a transmission to the wireless arrangement, the transmission including the identification data and wireless transmission data, and
wherein the wireless arrangement analyzes the identification data to determine the predetermined location, the wireless arrangement determining wireless coverage data at the location as a function of the transmission data.

2. The system according to claim 1, wherein the wireless arrangement generating wireless reception data as a function of the transmission, and wherein the wireless arrangement determines the wireless coverage data at the location as a function of the transmission data and the reception data.

3. The system according to claim 1, wherein the wireless arrangement includes a database storing the predetermined location.

4. The system according to claim 1, wherein the DAA is an optical scanning arrangement.

5. The system according to claim 1, wherein the DAA is a radio frequency scanning arrangement.

6. The system according to claim 1, wherein the identification data is stored in a barcode.

7. The system according to claim 1, wherein the transmission data comprises RSSI data, CRC errors, and ping data.

8. The system according to claim 1, wherein the item is merchandise.

9. The system according to claim 1, wherein the predetermined location is within a retail environment.

10. The system according to claim 1, wherein the wireless arrangement outputs wireless coverage data.

11. A method, comprising:
obtaining identification data from an item using a mobile unit, the item being located at a predetermined location;
generating wireless transmission data by the mobile unit;
sending a transmission to a wireless arrangement, the transmission including the identification data and the transmission data;
with the wireless arrangement, receiving the transmission;
determining the predetermined location as a function of the identification data; and
determining wireless coverage data at the location as a function of the transmission data and the reception data.

12. The method according to claim 11, further comprising:
with the wireless arrangement, generating wireless reception data as a function of the transmission,
wherein the determining step includes the substep of utilizing the transmission data and the reception data to determine the wireless coverage data at the location.

13. The method according to claim 11, wherein the wireless arrangement includes a database storing the predetermined location.

14. The method according to claim 11, wherein the mobile unit includes a data acquisition arrangement (DAA).

15. The method according to claim 13, wherein the DAA is an optical scanning arrangement.

16. The method according to claim 13, wherein the DAA is a radio frequency scanning arrangement.

17. The method according to claim 13, wherein the identification data is stored in a barcode.

19. The method according to claim 13, wherein the identification data is stored in a radio frequency identification tag.

18. The method according to claim 13, wherein the transmission data comprises RSSI data, CRC errors, and ping data.

19. The method according to claim 13, wherein the predetermined location is within a retail environment.

20. The method according to claim 13, further comprising:
outputting wireless coverage data.
